(19) United States
(12) Patent Application Publication
(10) Pub. No.: US 2023/0091478 A1
(43) Pub. Date: Mar. 23, 2023

(54) CONFIGURABLE STATE TRANSITION

(71) Applicant: HUAWEI TECHNOLOGIES CO., LTD., shenzhen (CN)

(72) Inventors: Jingliang Wang, Austin, TX (US); Noah Sherrill, Austin, TX (US)

(73) Assignee: HUAWEI TECHNOLOGIES CO., LTD., Shenzhen (CN)

(21) Appl. No.: 18/070,270

(22) Filed: Nov. 28, 2022

Related U.S. Application Data
(63) Continuation of application No. PCT/US2020/052727, filed on Sep. 25, 2020.
(60) Provisional application No. 63/031,493, filed on May 28, 2020.

(51) Int. Cl. G06F 30/3308; G06F 30/337

(52) U.S. Cl. CPC G06F 30/3308; G06F 30/337; G06F 2115/10

(57) ABSTRACT

According to one aspect of the present disclosure a system and method of enhancing random test case generation during pre-silicon design verification of test models of very large scale integration (VLSI) processors and systems is provided. A test sequence including a specification of at least one target state value for at least one resource of the hardware design model is received and includes a state object having at least one state element defining the target state value for a resource. Instructions are generated to transition the at least one resource from an existing state to the at least one target state value. The instructions are executed according to the test sequence to transition the resources to the defined state. State information on the hardware design model is output to allow a process engineer to determine whether the target state value for the resource was successfully changed.

### CLAIM OF PRIORITY

This application is a continuation of, and claims priority to, PCT Patent Application No. PCT/US2020/052727, entitled “CONFIGURABLE STATE TRANSITION”, filed Sep. 25, 2020, which claims priority to U.S. Provisional Patent Application No. 63/031,493, entitled “CONFIGURABLE STATE TRANSITION”, filed May 28, 2020, which applications are incorporated by reference herein in their entirety.

### FIELD

The disclosure generally relates to the field of verification of semiconductor integrated circuit hardware designs.

### BACKGROUND

The manipulation of simulated hardware designs using software seeks to verify the operation of such designs before committing the design to manufacture. Hardware design verification may rely on pseudo randomly generated test cases (or stimulus) to guarantee correct function of the design prior to tape-out. Random instruction sequence generators (ISGs) are important tools in the verification of hardware such as micro-processors and system-on-chip (SoC) hardware. Random ISGs produce randomized test cases that are run against test models of the processor and used to debug the function prior to release of the design to the fabrication facility. Such test cases may range from being fully randomized to being very tightly specified with the randomization being quite limited in scope. Fully randomized generation may require little effort on the part of the design engineer, but suffers from relying on the chance that the output of the pseudorandom choices of the generator will produce a test case that brings the test model into the desired state. Tightly constrained test cases may be more likely to achieve the desired state within the test model, but are labor intensive making it more difficult to get all of the appropriate test vectors written.

In addition, a large number of functions have to be verified. Verifying these numerous functions is complicated by the large number of different states the design can be in when each of those functions must be performed. A need exists, therefore, to develop a technology for verifying the numerous functions across the magnitude of different states.

### SUMMARY

Generally, to verify the function of a test model, generation of random test cases is partnered with appropriate coverage analysis tools, allowing advantageous testing of all of the different functions with the system in all of its possible states. According to one aspect of the present disclosure, there is provided a computer implemented method of determining the operability of an integrated circuit, including: receiving a test sequence including a specification of at least one target state value for at least one resource of the integrated circuit, the specification including a state object including at least one state element defining the target state value for the resource; generating a plurality of instructions to transition the at least one resource from an existing state to the at least one target state value; executing the instructions according to the test sequence to transition the at least one resource in the model to the defined state; after executing the instructions, outputting state information on the hardware design model to determine whether the target state value for the resource was successfully changed; and redesigning the model based on the outputting. Other embodiments of this aspect include corresponding computer systems, apparatus, and computer programs recorded on one or more computer storage devices, each configured to perform the actions of the methods.

Implementations may include one or more of an implemented method where the test sequence is defined in source code script and further including instantiating the state object to call a method to perform the generating. Implementations may include one or more of a method as described above where the resources include at least one of: general purpose registers (GPRs), floating point registers (FPRs), system registers, and system memory, and each state element defines a value of the resource after the state transition. Implementations may include one or more of a method as described above where the test sequence defines a processing order for the state elements. Implementations may include one or more of a method as described above where the script defines a test sequence which defines a processing order for the state elements by grouping similar state elements. Implementations may include one or more of a method as described above where the source code defines instruction sequences for more than one execution thread. Implementations may include one or more of a method as described above where the method further includes maintaining a mapping between each computer implemented execution thread and a thread executing the test model. Implementations may include one or more of a method as described above where the test sequence uses a default processing order for the state elements including an order the state elements are defined in the source code script. Implementations of the described techniques may include hardware, a method or process, or computer software on a computer-accessible medium.

Another general aspect includes a method of validating an integrated circuit design, the method including: defining a test sequence including a specification of at least one target state value for at least one resource of the integrated circuit device, the test sequence including defining a state object including at least one state element, the state element specifying the target state value for the resource, the test sequence including a state element order. The method of validating also includes the test sequence calling an automated instruction generator, the generator configured to generating a plurality of instructions to transition the at least one resource from an existing state to the at least one target state value; and the test sequence causing the executing the instructions according to the test sequence to transition the at least one resources to the defined state. The method of validating also includes after executing the instructions, receiving an output of state information for at least the resource of the hardware design model to determine whether the target state value for the resource was successfully changed. Other embodiments of this aspect include corresponding computer systems, apparatus, and computer programs recorded on one or more computer storage devices, each configured to perform the actions of the methods.

Implementations may include one or more of a method as described above where the test sequence is defined in source code script and further including instantiating the state object to call a method to perform the generating. Implementations may include one or more of a method as described above where the resources include at least one of: general purpose registers (GPRs), floating point registers (FPRs), system registers, and system memory, and each state element defines a value of the resource after the state transition. Implementations may include one or more of a method as described above where the test sequence defines a processing order for the state elements. Implementations may include one or more of a method as described above where the source code defines instruction sequences for more than one execution thread. Implementations may include one or more of a method as described above where the method further includes maintaining a mapping between each execution thread and a thread executing the test model. Implementations may include one or more of a method as described above where the test sequence uses a default processing order for the state elements including an order the state elements are defined in the source code script. Implementations may include one or more of a method as described above where the script defines a test sequence which defines a processing order for the state elements by grouping similar state elements. Implementations of the described techniques may include hardware, a method or process, or computer software on a computer-accessible medium.

Yet another aspect includes a processing device, including: a non-transitory memory storage including instructions; and one or more processors in communication with the memory storage, where the one or more processors execute the instructions to: receive a test sequence including a specification of at least one target state value for at least one resource of an integrated circuit model, the specification including a state object including at least one state element defining the target state value for the resource; generate a plurality of state transition instructions to transition the at least one resource from an existing state to the at least one target state value; executing the state transition instructions according to the test sequence to transition the at least one resources to the defined state; and after executing the state transition instructions, output state information on the integrated circuit design to determine whether the target state value for the resource was successfully changed to verify operation of the design. Other embodiments of this aspect include corresponding computer systems, apparatus, and computer programs recorded on one or more computer storage devices, each configured to perform the actions of the methods.

Implementations may include one or more of a processing device as described above where the test sequence is defined in source code script and further including instantiating the state object to call a processing device to perform the generating. Implementations may include one or more of a processing device as described above where the resources include at least one of: general purpose registers (GPRs), floating point registers (FPRs), system registers, and system memory, and each state element defines a value of the resource after the state transition. Implementations may include one or more of a processing device as described above where the test sequence defines a processing order for the state elements. Implementations may include one or more of a processing device as described above where the script defines a test sequence which defines a processing order for the state elements by grouping similar state elements. Implementations may include one or more of a processing device as described above where the source code defines instruction sequences for more than one execution thread. Implementations may include one or more of a processing device as described above where the processing device further includes maintaining a mapping between each execution thread and a thread executing the test model. Implementations may include one or more of a processing device as described above where the test sequence uses a default processing order for the state elements including an order the state elements are defined in the source code script.

Another general aspect includes a non-transitory computer-readable medium storing computer instructions for one or more processors, that when executed by one or more processors, cause the one or more processors to: receive a test sequence including a specification of at least one target state value for at least one resource of an integrated circuit design model, the specification including a state object including at least one state element defining the target state value for the resource; generate a plurality of state transition instructions to transition the at least one resource from an existing state to the at least one target state value; executing the state transition instructions according to the test sequence to transition the at least one resources to the defined state; and after executing the state transition instructions, output state information on the integrated circuit design model to determine whether the target state value for the resource was successfully changed.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures for which like references indicate the same or similar elements.

FIG. 1 is an overview block diagram depicting a testing environment suitable for implementing the described technology.

FIG. 2 is a flowchart representing an overview of the described technology.

FIG. 3 is a high-level block diagram of the instruction sequence generator (ISG).

FIG. 4 is a flowchart illustrating the respective steps performed by the frontend and backend of the ISG to enable configurable state transition in a test model.

FIG. 5 graphically represents the classes used in the method of FIG. 4.

FIG. 6 is a flowchart illustrating one exemplary method performed at step 460 of FIG. 4 to select a state transition manager.

FIG. 7 is a flowchart illustrating one exemplary method performed at step 470 of FIG. 4 to select a transition order.

FIG. 8 is a flowchart illustrating one exemplary method performed at step 490 of FIG. 4 to invoke each state transition handler to generate instructions for a state transition

FIG. 9A is an example of the template code to reset a block of memory.

FIG. 9B is an example of template code in the ISG choosing state transitions at random from a collection of state transitions.

FIG. 10 illustrates a number of state elements options for a given state.

FIG. 11 is a block diagram of a network device that can be used to implement various embodiments.

### DETAILED DESCRIPTION

The present disclosure and embodiments address a novel method of enhancing random test case generation within the context of pre-silicon design verification of test models of very large scale integration (VLSI) processors and systems. The present disclosure describes technology which allows the specification of device states (including intermediate states) that a generated test case must achieve within a test model. Using the described technology, the design verification engineer can efficiently specify the target states for the test model to an instruction sequence generator (ISG), and the ISG will produce a test (execution) case having a sequence of instructions or commands to create the targeted state in the test model. This configurable state transition provides a novel way of enhancing random test case generation within the context of pre-silicon design verification of VLSI processors and systems. The test generation is random since the verification engineer need not write the sequence of instructions needed to achieve the intermediate or final state of the system's resources which are being tested. This configurable state transition makes it easier for the verification engineer to target specific verification scenarios in the test model by specifying the specific states that must be achieved while still using generated randomized test cases.

The technology described herein is applicable to any form of integrated circuit which includes, without limitation, processors, microprocessors, memories, SoCs or other hardware devices which are manufactured on substrates of a semiconductor material.

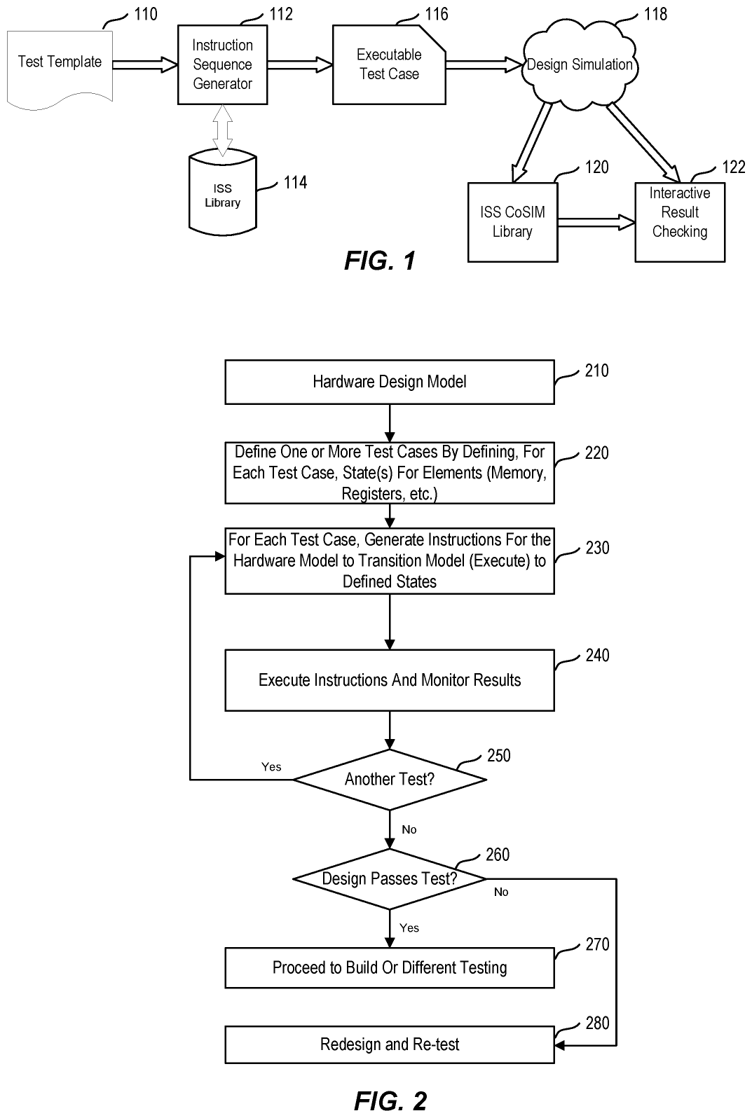

FIG. 1 is an overview block diagram depicting a testing environment suitable for implementing the technology described herein. Illustrated in FIG. 1 is an instruction sequence generator (ISG) 112 which generates an executable test case 116 comprising instructions for transitioning a test model of a hardware design to a desired state in a design simulation environment 118. The instruction sequence generator accesses an instruction set simulator (ISS) library 114 which include instruction sequences for use by the ISG 112. The ISG executes each generated instruction using the ISS library 144 which maintains the hardware test model states. A test template 110 is used to instruct the ISG 112 to create the executable test case 116 by defining the state values for resources in the test model and other options as described herein for creating the test case 116. The design simulation environment 118 includes an instruction sequence simulation co-simulation library 120 which allows for interactive result tracking 122 by the process engineer.

FIG. 2 is a flowchart representing an overview of the technology described herein. At 210, a hardware model of the integrated circuit to be tested is developed by a hardware designer. In the context of the present disclosure, the hardware model or “test model” is a software design of a hardware device intended to be constructed in a semiconductor fabrication facility that would benefit by software validation testing prior to being committed to manufacture. At 220, one or more test cases are created by defining, for each test case, intermediate or target resource states for resources in the test model. Each test case includes one or more state transitions of the resource of a test model from an existing state to a different (intermediate or target) state. In the context of the present disclosure, the “target” state is defined by a verification engineer using the test template 110. The term “state” as used herein with respect to the test model may include defined values or “states” in a device model resource field (memory, register or the like) in the test model. For example, a processor has state that is defined by a target instruction set architecture (ISA) (for example—the ARM, x86, S/370, and RISC-V architectures) which defines values for the processor's general purpose registers (GPRs), floating point registers (FPRs), system registers, memory, and/or other resources. Each state includes one or more values which, in the context of the present disclosure, are defined as state elements. A state element defines a resource in the test model, such as a set of memory addresses or a general purpose register, along with the intended (or test) value of the resource after the state transition.

One example of a state transition is the change in the contents of a RISC-V general purpose register from one value to a different value. For example, an initial value may be 0x1234, with the new or target value being 0x1278. Another example of a state transition is the change in the value of the contents of a memory location. For a given memory address of, for example, 0x00FF00B0, the contents of that location might initially be 0x0000000 but undergo a state transition to change the contents to a different value such as 0xAA55AA55. The configurable state transition of the described technology provides a mechanism for a verification engineer to specify a state transition to the ISG from a top-level template (110) without the need to specify a specific instruction sequence to implement that state transition.

At 230, for each test case, the ISG generates instructions for the test model to transition the modeled hardware to the defined target state. As discussed herein, the ISG is a random instruction sequence generator which performs this task based on the template definition. In one embodiment, the ISG generates instruction sequences automatically based on the defined test state or states for each resource defined in the test. At 240, the instructions are executed by the test model and results monitored for each test. At 250, a determination is made as to whether additional tests are to be performed. If so, then the method returns to step 230 for the next test. If not, then once all tests are completed at 250, a determination is made at 260 as to whether the design passes the test. If not, the hardware model may be re-designed at 280. If so, additional testing may still be required for other components of the design or the hardware may be ready to proceed to build at 270.

Step 270 may include those steps necessary to complete the fabrication of the integrated circuit that is the subject of the hardware model. This includes front-end semiconductor fabrication steps comprising the physical creation, or fabrication, of the semiconductor as well as back-end assembly, testing, and packaging.

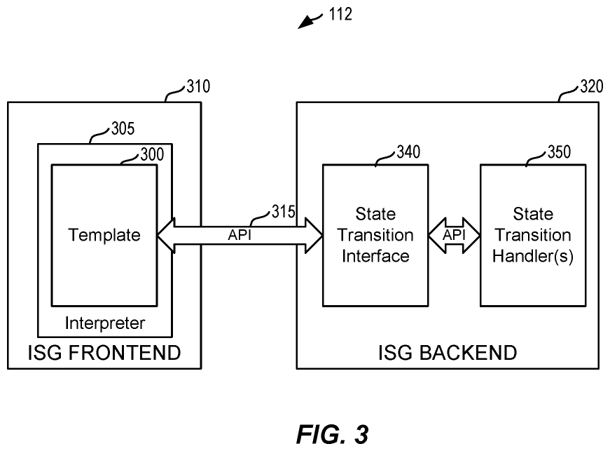

FIG. 3 is a high-level block diagram of the ISG 112. In one implementation, the ISG may be comprised of a frontend 310 and backend 320. The frontend 310 includes a top level template 300 (which in one embodiment is a set API calls written in the Python (or other similar type of programming language)) which guides the instruction sequence generation, and an interpreter 305 (which may in one embodiment be a Python interpreter) which provides a Python programming language interface to the APIs 315 provided by the ISG backend 320. The backend 320 of the ISG performs random instruction generation functions and provides API 315 that exposes those functions to the frontend 310. The ISG backend 320 includes a state transition interface 340 which interfaces with one or more state transition handlers 350 to provide configurable state transition for the hardware model. Each state transition handler 350 provides the instruction sequences necessary to affect a specified state within the test model.

Template 300 is, in one embodiment, a Python program which generally defines the test functions that are required to be verified and may vary in length depending on the specific test functions required. The template 300 controls how specific APIs to the ISG backend 320 are called and it is the calls to the methods in the API 315 that generate instructions based on pseudorandomized generation and parameters passed in the API calls.

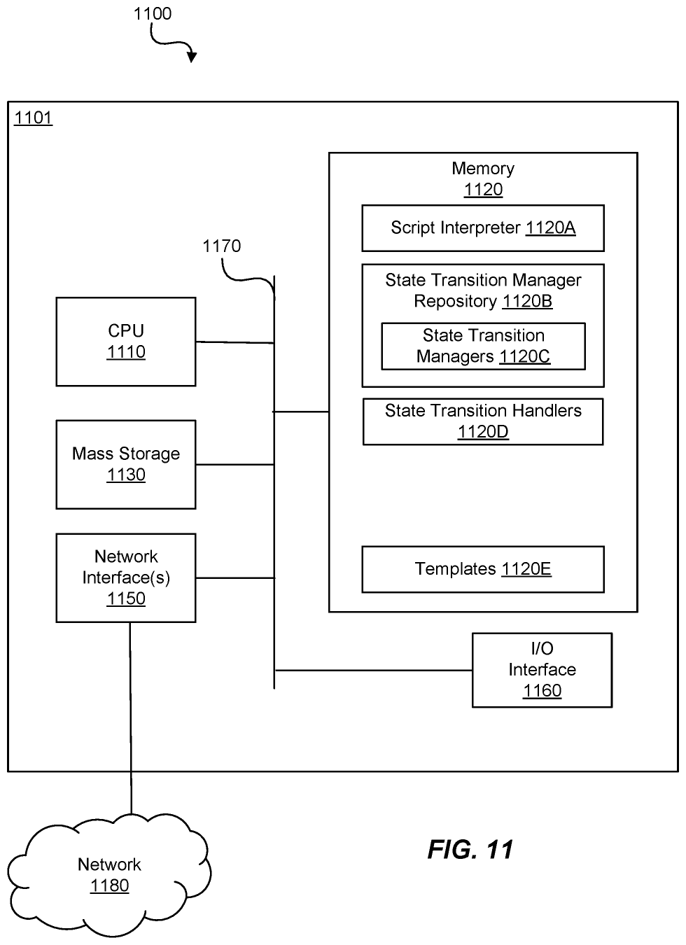

In various implementations, the frontend 310 may be operable on a first processing device which communicates with the backend which is operable on a second processing device through the application programming interface 315. In another embodiment, both the frontend and the backend may be operable on one processing device such as that illustrated in FIG. 11. While the interpreter and template are described with respect to a Python template and a Python language interpreter, the particular source code language is not restricted to Python and one of average skill will recognize that other types of interpreters and programming languages may be utilized without departing from the scope of the described technology.

The frontend 310 uses the interpreter 305 to provide an interface to a series of functions (instructions operable on a processing device) callable by the template code via the API 315. Each template may use a sequence of API calls to build a test case. Various examples of such modules may include API calls to generate instructions, obtain random physical or virtual addresses, obtain or get free memory pages, get random registers or general purpose registers, initialize and reserve (or unreserve) memory, lock and unlock threads, etc. The nature of each of these APIs can be customized for the particular hardware model (test model) and instruction set under testing by the technology described herein.

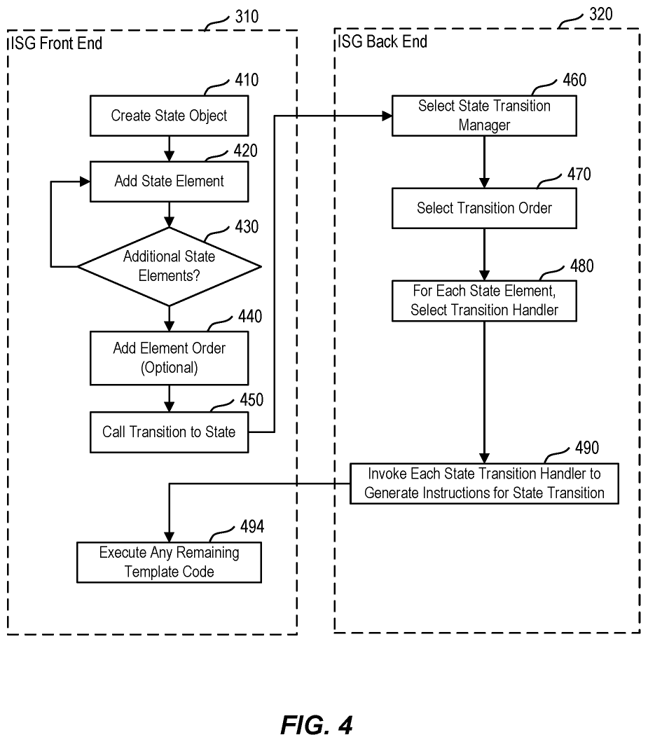

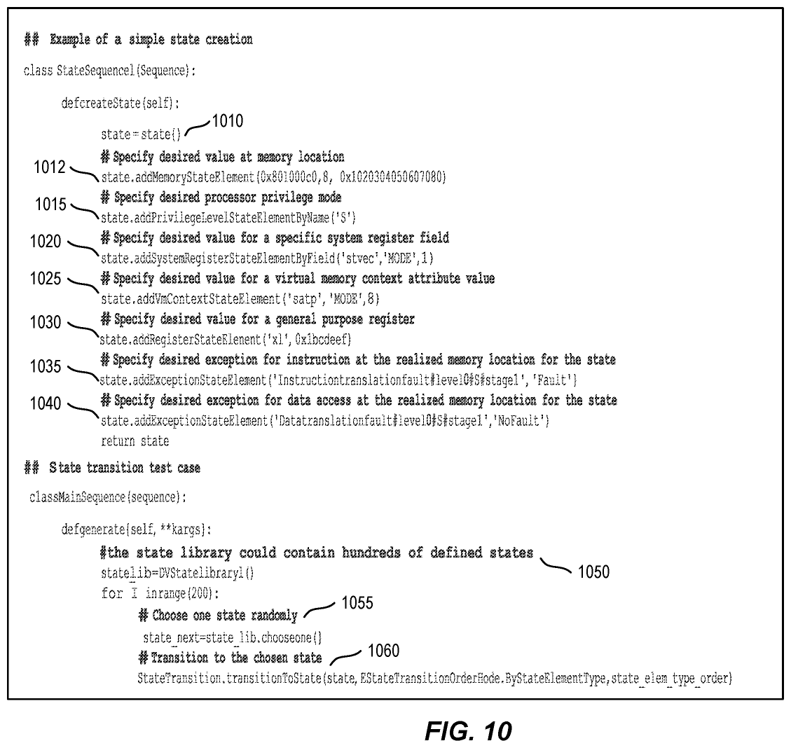

FIG. 4 is a flowchart illustrating the respective steps performed by the frontend 310 and backend 320 to enable configurable state transition in a test model. Initially, at 410, a state object is created using a template which creates the state objects in the backend for various state elements using API 315. Each state object may have added to it one or more state elements at 420. Additional state elements at 430 may be included for each state object. Multiple state elements can be added at 430 with one for each resource that is to be changed to a new value. Examples of various state elements which may be included are shown and discussed with respect to FIGS. 10A and 10B. Optionally, an element processing order for the ISG backend may be included at 440. By default, transitions in the back end 320 are executed in the order the elements are specified, but a specific order can be defined in the template.

When no additional state elements are defined as part of the testing and verification process, a transition-to-state method is invoked at 450.

At 460, a state transition manager is selected based on each thread ID of the template sequence calling the transition-to-state method. The state transition manager is responsible for assigning state transition handlers to perform state transitions. Each state transition manager manages the steps of updating the resources in the test model. The templates can be coded to generate instruction sequences for more than one execution thread. As such, there is a state transition manager for each thread and a mapping between the processor threads executing the test model and in the transition manager itself. Consequently, the thread executing the transition-to-state method is mapped to the test model thread being executed by the processor running the test method.

At 470, the state transition manager looks up the transition order that is to be used. If no state transition order for the state elements is specified in the template, a default state transition order is used. Based on the transition order and the state transition handler(s) for that a given ID, at 480 for each state element, the state transition manager selects a state transition handler for that element and at 490, invokes each of the state transition handlers to perform all of the resource value updates required by the state elements in the state object.

After the state transition is complete, at 495 control is returned to the template code to continue with its processing of any additional code in the template.

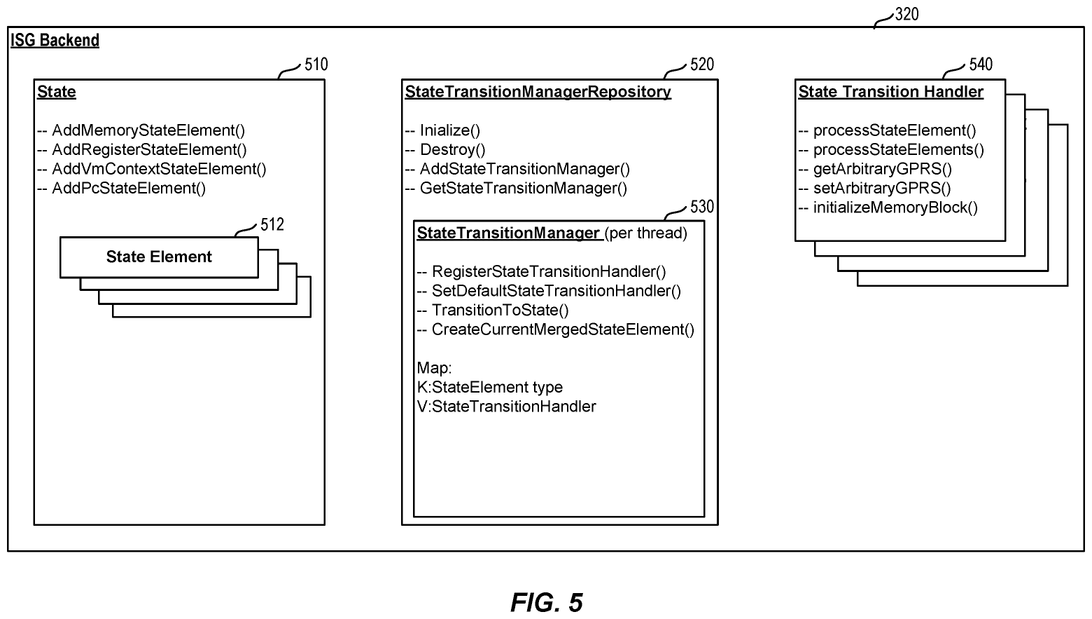

FIG. 5 graphically represents the aforementioned classes used in the method of FIG. 4, and their interaction with each other and the Python template. Each state object 510 maintains a collection of state elements 512 that are added to the object in the backend 320 via the API 315. Using the template, a verification engineer can create a state element for each resource in the test model that is to be changed as part of the state transition and add it to the state object. There are different state element types which correspond to different resource types. There are Register State Elements (AddRegisterStateElement), Memory State Elements (AddMemoryStateElement), Virtual Memory state elements (AddVmContextStateElement), and the like.

The state transition manager 530 is responsible for assigning state transition handlers 540 to perform state transitions. The state transition handlers 540 manage the steps of updating the resources in the test model. As noted above, the template can be coded to generate instruction sequences for more than one execution thread. In such cases, there is one state transition manager per thread. The state transition manager repository 520 maintains a map between the thread and the state transition managers 530 so that the proper state transition manager can be called when a state transition is requested. The repository includes methods to initialize, destroy, get and add state transition mangers.

The state transition manager 530 also maintains a mapping between the state element type (register, memory, etc. . . . ) and the state transition handlers so that, if desired, a different state transition handler can be used for each type of state element. A default state transition handler is provided for each type of state element. The verification engineer can provide a different state transition handler creating a subclass of the state transition handler and overriding the processStateElement( ) method.

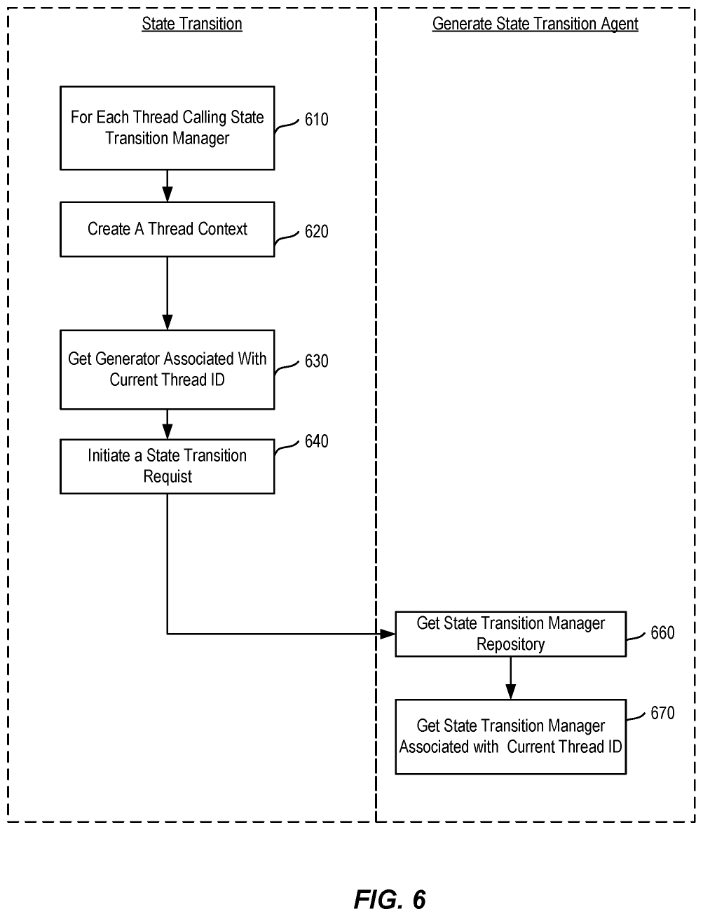

FIG. 6 is a flowchart illustrating a method performed at step 460 to select a state transition manager. FIG. 6 illustrates the steps, which are performed by in one embodiment, a state transition method and a generate state transition agent method. At 610, for each thread calling a state transition manager, at 620, a thread context is created. The thread context object then gets the current thread ID at 630 from the thread context. The thread context in turn requests the thread ID from the thread dispatcher. At 630, the generator that is associated with the current thread is identified and retrieved. At 640, a state transition request is initiated to the generator. The generator passes the request to the generate state transition agent for processing. At 660, the state transition manager repository is retrieved. At 670, the current thread ID is used to look up the appropriate state transition manager and the state transition manager proceeds to execute the state transition.

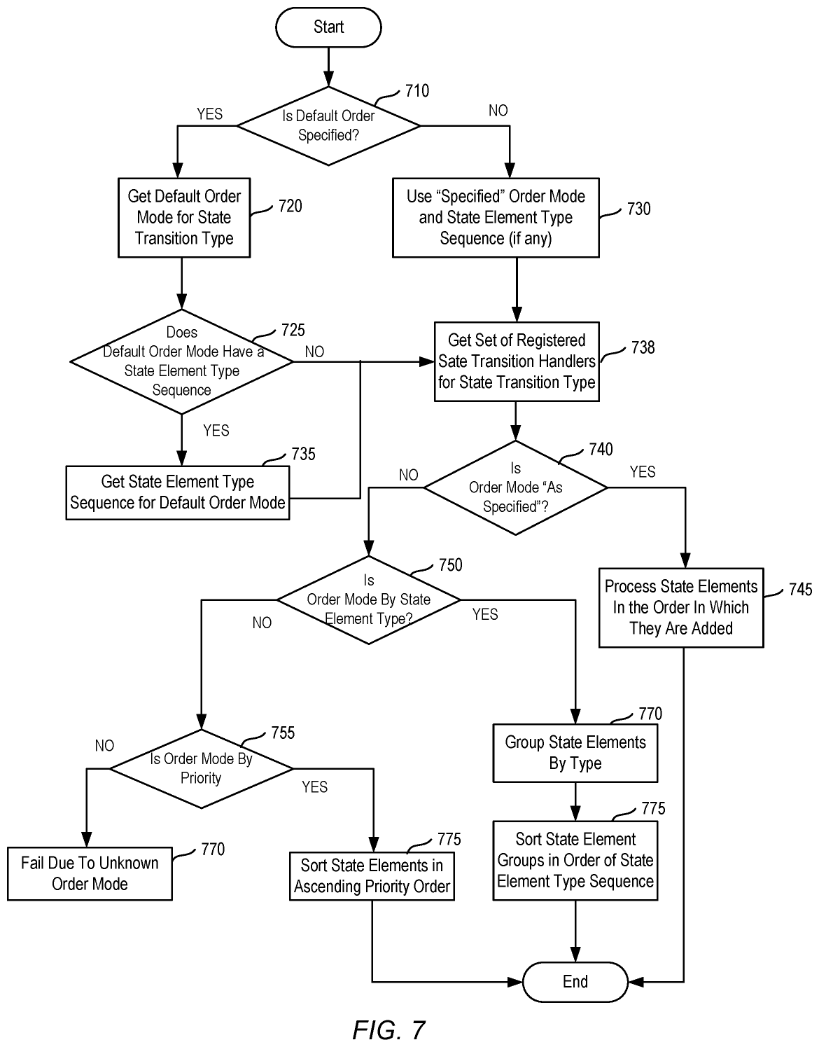

FIG. 7 is a flowchart illustrating one exemplary method performed at step 470 to select a transition order. In general, the method illustrated in FIG. 7 operates to determine the order in which to execute the state elements or state element groups. Initially, at 710, determination is made as to whether not a “default order” mode is specified. If so, then at 720, the default order mode for the state transition type is retrieved. At 725, a determination is made as to whether or not the default order mode has a “state element type” sequence. If so, then at 735, the state element type sequence for the default order mode is retrieved and a set of registered state transition handlers is retrieved for the state transition type at 738. If at 725, the “default” order mode does not have a state element type sequence, then at 735, the state element type sequence for the default order mode is retrieved and a set of registered state transition handlers is retrieved for the state transition type at 738.

If no “default” order is specified at 710, the method uses the “specified order” mode and state element type sequence at 730. At 738, again, the set of registered state transition handlers for the state transition type is retrieved. Next, at 740, a determination is made as to whether the “as specified” order mode is defined. If so, then the state elements are processed in the order in which they are added at 745. If not, a determination is made as to whether not the order mode is “by state element type” at 750. If so, then the state elements are grouped by type at 770, and the state element groups are sorted in the order of the state element type sequence at 775. If at 750 the order mode is not by state element type, then at 755 a determination is made as to whether or not the order mode is determined “by priority.” If so, then at 775, the state elements are sorted in ascending priority ordered. If not, then at 770, the method fails due to an unknown word order mode.

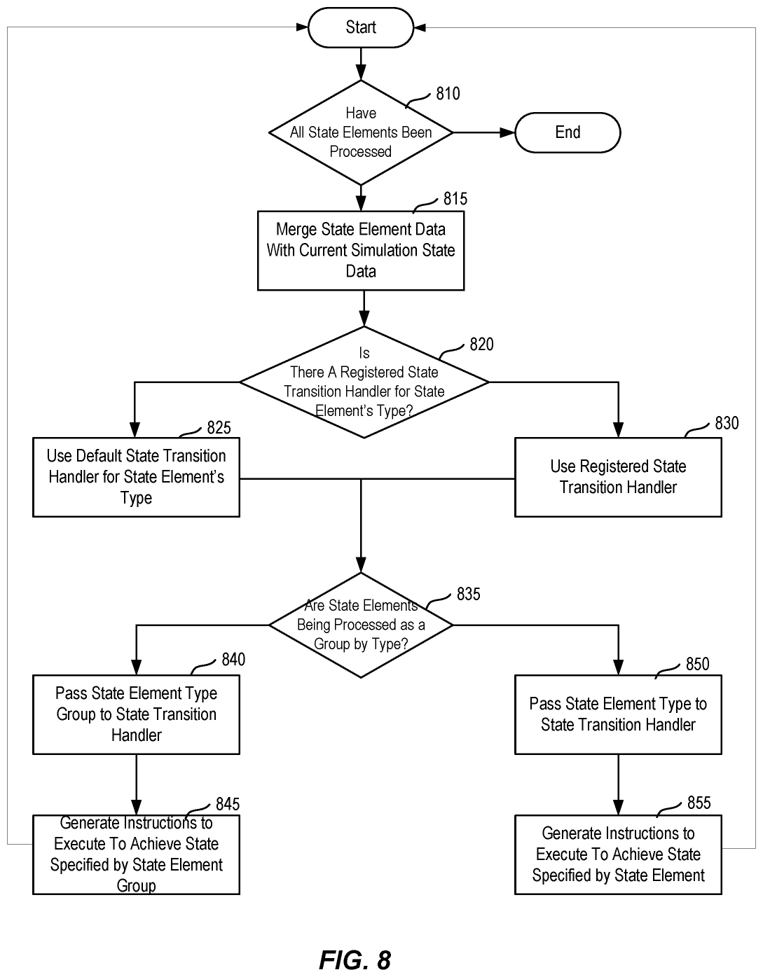

FIG. 8 is a flowchart illustrating one exemplary method performed at step 490 to invoke each state transition handler to generate instructions for a state transition. Initially, at 810, if there are additional state elements to be processed, the method continues to 815. If not, the processing ends. At 815, the method merges current state element data with the current simulation state data. At 815, if the state element fully specifies an underlying state information, such as a program counter (PC) value, nothing needs to be performed at step 815 since the value can simply be written to the counter. But if the state element only partially specifies the underlying state information, such as a register field, then the current simulation state is merged with the state element value. At 820, a determination is made as to whether or not there is a registered state transition handler for the state element type. If so, then the registered state transition handler for the state element type is used at 830. If not, a default state transition handler for the state element type is utilized at 825. Next, a determination is made as to whether or not the state elements are being processed as a group by state element type or individually. If the state elements are being processed as a state element group by type, the entire group is passed to the state transition handler at 840 and instructions are generated 845 to execute in the simulation environment to achieve the specified state by state element group. If, at 835, the state elements are being processed individually, then the single state element is passed to the state transition handler at 850 and instructions generated to achieve the specified state specified by the state element. The method then loops back to step 810 to continue processing.

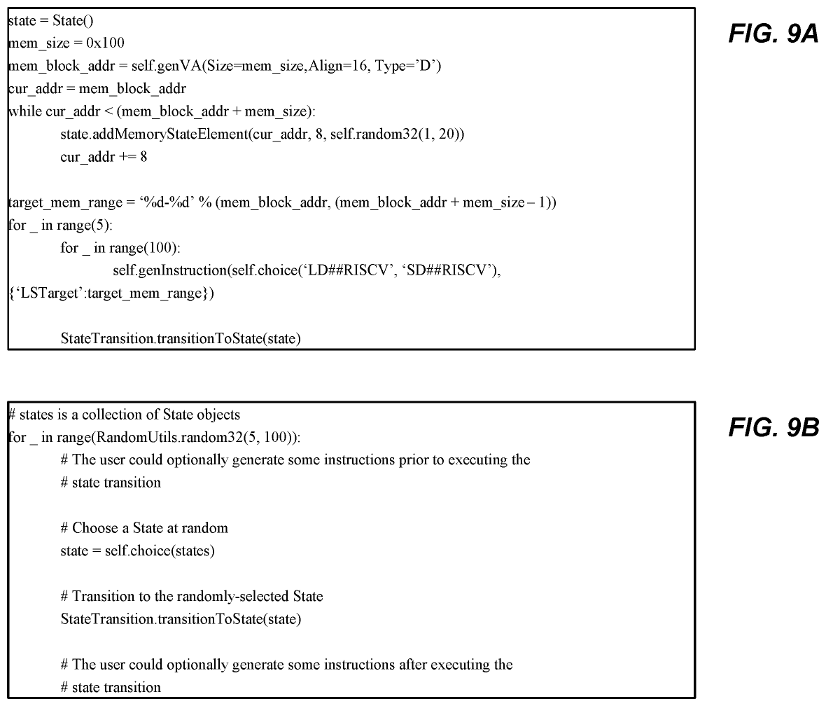

FIG. 9A is an example of the template code to reset a block of memory. As shown in FIG. 9A, the state object (state( )) is created, and multiple state elements (a specification of memory size, a specification of the memory block address as self-generated and the target memory range) are added to the state object to reflect the memory locations to be updated when a state transition is requested. Inside the “for” loop, after 100 load/store instructions are generated, the transition-to-state method is used to reset the value of the targeted memory locations. Again, code need not be written to define an appropriate sequence of instructions for the test model in order to reset the memory. Defining a state and then requesting a transition-to-state method eliminates the need for specific code written by the verification engineer to accomplish the state transition update of memory.

FIG. 9B is an example of template code in the ISG frontend choosing state transitions at random from a collection of state transitions. In FIG. 9, the format of the template allows the user to optionally generate instructions prior to executing the state transition, choose a state at random, transition to the randomly selected state, and generate further instructions after executing the state transition. Once a sequence of states has been defined, the user can easily generate transitions between randomly selected states with minimal additional work, as FIG. 9 illustrates state transitions can be used, reused, and combined in powerful ways. For example, state transitions can be conveniently combined to implement or extend coverage for transitioning between States. A user may define a set of States, may import States from a library or may do a combination of the two.

FIGS. 10A and 10B illustrate a number of state element options for controlling target states. As noted above, a state element defines a resource in the test model, such as a set of memory addresses or a general purpose register, along with the intended value after the state transition. One to many state elements can be added to the state object, and each can contain a wide array of information. For example, as illustrated in FIG. 10A, in the RISC-V architecture, a given state 1010 could specify a desired value at a memory location (1012). Another state element could specify the supervisor privilege level (1015). Another state element can specify a desired value for a specific system register field (1020). Yet another can specify a desired value for a VM Context State Element attribute value (1025) or a VM Context State Element could specify the 48-bit virtual addressing mode. State elements can specify a desired value for a general purpose register (1025). A further state element can specify a desired exception for an instruction at a realized memory location for a state (1035), or a desired exception for data access at the realized memory location (1040). These exceptions essentially control whether the state object will trigger an exception or not. State elements can specify a hierarchy for memory states such as caching attributes, page aliasing, page size and the like. For example, as illustrated in FIG. 10B, an example of adding a memory hierarchy specification to a state object is shown. Initially, a state definition includes instantiating a choices modifier (1070). For a given page size selection, (illustrated in FIG. 10B in terms of 4 Kb, 2 Mb, 1 Gb and 512 Gb page sizes) the relative weight for each size can be adjusted (1075). The relative weights of instruction page aliasing (no-aliasing vs. aliasing) (1080) and data cachable weights. These weights are of two types: cacheable vs. non-cachable. The memory definition is then added to the state object at 1090. In other examples, a page-sized block of memory state elements could be specified such that the value of each 8-byte aligned address contains another 8-byte aligned address within the same page. Register state elements could further be specified to ensure each GPR contains a value representing an address in the given page. Register state elements could specify register field values and register values to enable read only access for a portion of the physical addresses mapped to by the page, read-write access for another portion and no access for a third portion. It should be understood that the aforementioned examples of state elements represent only a subset of the available state elements which can be defined.

A state transition can have multiple state elements defining changes to different resources of the same type and of different types. When the state transition occurs, all of the resources will be updated. By default, the state elements will be processed by the state-transition-handler in the order in which they were added to the state object. The verification engineer may alternatively specify that the updates be grouped by state element type, in which case a default ordering for which type of state element is updated (first, second, etc. . . . ) Is used. The verification engineer may specify a custom ordering for the state elements if desired. When doing so, the verification engineer must keep in mind any side effects of instruction execution that might occur which could potentially overwrite previously performed updates within the state transition.

During the course of execution of the template, at the point desired by the verification engineer, a transition-to-state method is called which causes the generator to produce code that transitions the test model to the new state. After transitioning to the resulting State, the template might generate a series of random zero-offset load and store instructions that would all be guaranteed to target addresses in the given page. Each successful load instruction would insert an address within the given page range into the destination GPR.

FIG. 11 is a block diagram of a network device 1100 that can be used to implement various embodiments. Specific network devices may utilize all of the components shown, or only a subset of the components, and levels of integration may vary from device to device. Furthermore, the network device 1100 may contain multiple instances of a component, such as multiple processing units, processors, memories, transmitters, receivers, etc. The network device 1100 may include a central processing unit (CPU) 1110, a memory 1120, a mass storage device 1130, and an I/O interface 1160 connected to a bus 1170. The bus 1170 may be one or more of any type of several bus architectures including a memory bus or memory controller, a peripheral bus or the like.

The CPU 1110 may comprise any type of electronic data processor. The memory 1120 may comprise any type of system memory such as static random-access memory (SRAM), dynamic random-access memory (DRAM), synchronous DRAM (SDRAM), read-only memory (ROM), a combination thereof, or the like. In an embodiment, the memory 1120 may include ROM for use at boot-up, and DRAM for program and data storage for use while executing programs.

In embodiments, the memory 1120 is non-transitory. In one embodiment, the memory 1120 includes a script interpreter 1120A, a state transition manager repository 11206, one or more state transition managers 1120C, one or more state transition handlers 1120D and one or more templates 1120E. Any one or more of these elements may be stored as instructions on the mass storage device 1130. The instructions may be operable to control the CPU 1110 to perform the functions described above with respect to these elements.

The mass storage device 1130 may comprise any type of storage device configured to store data, programs, and other information and to make the data, programs, and other information accessible via the bus 1170. The mass storage device 1130 may comprise, for example, one or more of a solid-state drive, hard disk drive, a magnetic disk drive, an optical disk drive, or the like.

The mass storage device may also store the any of the components described as being in or illustrated in memory 1120 to be read by the CPU and executed in memory 1120. The mass storage device may comprise computer-readable non-transitory media which includes all types of computer readable media, including magnetic storage media, optical storage media, and solid-state storage media and specifically excludes signals. It should be understood that the software can be installed in and sold with the network device. Alternatively the software can be obtained and loaded into network device, including obtaining the software via a disc medium or from any manner of network or distribution system, including, for example, from a server owned by the software creator or from a server not owned but used by the software creator. The software can be stored on a server for distribution over the Internet, for example.

The network device 1100 also includes one or more network interfaces 1150, which may comprise wired links, such as an Ethernet cable or the like, and/or wireless links to access nodes or one or more networks 1180. The network interface 1150 allows the network device 1100 to communicate with remote units via the networks 1180. For example, the network interface 1150 may provide wireless communication via one or more transmitters/transmit antennas and one or more receivers/receive antennas. In an embodiment, the network device 1100 is coupled to a local-area network or a wide-area network 1180 for data processing and communications with remote devices, such as other processing units, the Internet, remote storage facilities, or the like.

The configurable state transition of the described technology enhances the capability of the ISG by allowing the verification engineer to make a call to the transition-to-state method rather than write all of the code necessary to update a test model to a new state. The environment provided by the ISG to the template code is well suited for generating randomized instructions and code streams. This provides flexibility by allowing the verification engineer to write specific code to update resources and providing it to the state transition handler(s) if needed for certain scenarios.

This solves the testing problems described in the background by giving the verification engineer an efficient mechanism to generate randomized sequences of instructions that can update the test model resource state at intermediate points in the test case. This makes it easier to target testing of hard to achieve states within the test model. Because this can be done using the ISG, the instruction sequence generation can continue under control of the ISG. This is an additional ability to control or steer the test cases that are produced by the ISG, and it gives the random test case generation a better ability to address hard to achieve states while still enjoying the benefit of being generated. In one embodiment, the random test cases can be automatically generated, easing the burden on the verification engineer.

Further advantages of the configurable state transition technology include allowing a user to specify the intended state of the resources in the test model by providing a mechanism such as a state object that holds the new target state values for the resources defined in the state elements added to the state object. This allows the user to invoke the state transition at any point in the test sequence including locations other than the initial conditions and including multiple times within the test sequence. The mechanism to do this is making a method call to the transition-to state method that is given a pointer to the State object containing all of the state updates required for the state transition. The technology also provides default sequences of code with state transition handlers that perform the actual state transition while allowing a user the ability to substitute their own code for the state transition handler to use in the state transition.

For purposes of this document, it should be noted that the dimensions of the various features depicted in the figures may not necessarily be drawn to scale.

For purposes of this document, reference in the specification to “an embodiment,” “one embodiment,” “some embodiments,” or “another embodiment” may be used to describe different embodiments or the same embodiment.

For purposes of this document, a connection may be a direct connection or an indirect connection (e.g., via one or more other parts). In some cases, when an element is referred to as being connected or coupled to another element, the element may be directly connected to the other element or indirectly connected to the other element via intervening elements. When an element is referred to as being directly connected to another element, then there are no intervening elements between the element and the other element. Two devices are “in communication” if they are directly or indirectly connected so that they can communicate electronic signals between them.

Although the present disclosure has been described with reference to specific features and embodiments thereof, it is evident that various modifications and combinations can be made thereto without departing from scope of the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

The foregoing detailed description has been presented for purposes of illustration and description. It is not intended to be exhaustive or to limit the subject matter claimed herein to the precise form(s) disclosed. Many modifications and variations are possible in light of the above teachings. The described embodiments were chosen in order to best explain the principles of the disclosed technology and its practical application to thereby enable others skilled in the art to best utilize the technology in various embodiments and with various modifications as are suited to the particular use contemplated. It is intended that the scope be defined by the claims appended hereto.

What is claimed is:

1. A computer implemented method of determining the operability of an integrated circuit, comprising:
receiving a test sequence including a specification of at least one target state value for at least one resource of a model of the integrated circuit, the specification including a state object including at least one state element defining the target state value for the resource;
generating a plurality of instructions to transition the at least one resource from an existing state to the at least one target state value;
executing the instructions according to the test sequence to transition the at least one resource in the model to the defined state;
after executing the instructions, outputting state information on the hardware design model to determine whether the target state value for the resource was successfully changed; and
redesigning the model based on whether the state information was successfully changed.

2. The computer implemented method of claim 1 wherein the test sequence is defined in source code script and further including instantiating the state object to call a method to perform the generating.

3. The computer implemented method of claim 2 wherein the test sequence includes a default processing order for the state elements comprising an order the state elements are defined in the source code script.

4. The computer implemented method of claim 2 wherein the script defines a test sequence which defines a processing order for the state elements by grouping similar state elements.

5. The computer implemented method of claim 2 wherein the source code defines instruction sequences for more than one execution thread.

6. The computer implemented method of claim 5 wherein the method further includes maintaining a mapping between each of a computer implemented execution thread and an execution thread executing the test model.

7. A processing device, comprising:
a non-transitory memory storage comprising instructions; and
one or more processors in communication with the memory storage, wherein the one or more processors execute the instructions to:
receive a test sequence including a specification of at least one target state value for at least one resource of an integrated circuit design model, the specification including a state object including at least one state element defining the target state value for the resource;
generate a plurality of state transition instructions to transition the at least one resource from an existing state to the at least one target state value;
executing the state transition instructions according to the test sequence to transition the at least one resources to the defined state; and
after executing the state transition instructions, output state information on the integrated circuit design model to determine whether the target state value for the resource was successfully changed to verify operation of the design.

8. The processing device of claim 7 wherein the test sequence is defined in source code script and further including instantiating the state object to call a processing device to perform the generating.

9. The processing device of claim 7 wherein the resources comprise at least one of: general purpose registers (GPRs), floating point registers (FPRs), system registers, and system memory, and each state element defines a value of the resource after the state transition.

10. The processing device of claim 7 wherein the test sequence defines a processing order for the state elements.

11. The processing device of claim 8 wherein the test sequence uses a default processing order for the state elements comprising an order the state elements are defined in the source code script.

12. The processing device of claim 8 wherein the script defines a test sequence which defines a processing order for the state elements by grouping similar state elements.

13. The processing device of claim 8 wherein the source code defines instruction sequences for more than one execution thread.

14. A non-transitory computer-readable medium storing computer instructions for one or more processors, that when executed by one or more processors, cause the one or more processors to:
receive a test sequence including a specification of at least one target state value for at least one resource of an integrated circuit device design model, the specification including a state object including at least one state element defining the target state value for the resource;
generate a plurality of state transition instructions to transition the at least one resource from an existing state to the at least one target state value;
executing the state transition instructions according to the test sequence to transition the at least one resource to the defined state; and
after executing the state transition instructions, output state information on the integrated circuit design model to determine whether the target state value for the resource was successfully changed.

15. The non-transitory computer-readable medium of claim 14 wherein the test sequence is defined in source code script and the instructions cause the one or more processors to instantiate the state object to call a method to perform the generating.

16. The non-transitory computer-readable medium of claim 14 wherein the test sequence defines a processing order for the state elements.

17. The non-transitory computer-readable medium of claim 15 wherein the test sequence uses a default processing order for the state elements comprising an order the state elements are defined in the source code script.

18. The non-transitory computer-readable medium of claim 15 wherein the source code script defines a test sequence which defines a processing order for the state elements by grouping similar state elements.

19. The non-transitory computer-readable medium of claim 15 wherein the source code script defines instruction sequences for more than one execution thread.

20. The non-transitory computer-readable medium of claim 19 wherein the instructions further cause the processor to maintain a mapping between each execution thread and a thread executing the test model.
